(19) United States
(12) Patent Application Publication
(10) Pub. No.: US 2025/0200633 A1
(43) Pub. Date: Jun. 19, 2025

(54) SINGLE CHECKOUT AND PURCHASE RECOMMENDATIONS IN A MULTI-VENDOR E-COMMERCE SYSTEM

(71) Applicant: Matthew R. Laue, Las Vegas, NV (US)

(72) Inventor: Matthew R. Laue, Las Vegas, NV (US)

(21) Appl. No.: 18/543,255

(22) Filed: Dec. 18, 2023

(51) Int. Cl. G06Q 30/0601

(52) U.S. Cl. CPC G06Q 30/0631; G06Q 30/0625; G06Q 30/0643

(57) ABSTRACT

Systems and methods enable a first e-commerce vendor to sell products and/or services provided by a second e-commerce vendor without the first vendor directly establishing a reseller agreement with the second e-commerce vendor. In some embodiments, when an online customer is shopping via an e-commerce sales mechanism for a first vendor, such as a shopping application or a website associated with the first vendor, a third-party e-commerce facilitator provides purchasing recommendations to the online customer for products and/or services provided by the second vendor. Further, the online customer completes purchases of products and/or services provided by the second vendor via a checkout process in the e-commerce sales mechanism for the first vendor.

### BACKGROUND

Unless otherwise indicated herein, the approaches described in this section are not prior art to the claims in this application and are not admitted to be prior art by inclusion in this section.

E-commerce, which is the method of buying and selling goods and services online, provides e-commerce vendors access to a much larger potential customer base than that available to a conventional brick-and-mortar seller. Specifically, e-commerce leverages the Internet so that anyone with an Internet connection is a potential customer for an e-commerce vendor, which is especially beneficial for small vendors.

However, small e-commerce vendors still struggle for exposure to potential customers. First, the e-commerce space is crowded with millions of e-commerce vendors. Second, the typical small e-commerce vendor is unknown to the vast majority of potential customers. A reseller agreement between two e-commerce vendors allows each vendor to sell products or services provided by the other vendor, but arranging such inter-vendor cooperation on a case-by-case basis is unwieldy and only incrementally increases exposure of a small vendor to additional customers. Consequently, approaches have been developed to differentiate a small vendor from the millions of other e-commerce vendors and to give the small vendor more visibility with likely customers in the crowded e-commerce space.

Currently, a vendor can contract to be an independent seller with a large online retailer, so that the vendor's products or services can be suggested to a customer searching for related products or services via the online retailer's website. Such agreements enable the vendor to benefit from the brand recognition and website infrastructure of the on-line retailer. However, independent-seller agreements also have drawbacks for the small vendor. For example, the vendor is usually subject to numerous fees that can negate much of the profits from sales through the online retailer, including plan membership fees, a referral fee for each item sold, paying for search rank and advertising, and the like. Another drawback is that sales through the online retailer provide little or no opportunity for customer acquisition by the independent seller, which is a key aspect of e-commerce. Instead, the online retailer generally retains most or all customer information acquired through purchases from the independent seller, and prevents or discourages customers from directly visiting a website associated with the independent seller. Thus, being an independent seller with a large online retailer can provide some increase in sales, but the independent seller is generally unable to expand its customer base, which is critical for success in e-commerce.

In light of the above, there is a need in the art for enhancing online sales and expanding the number of potential customers for individual e-commerce vendors.

### SUMMARY

According to various embodiments, systems and methods are disclosed that enable a first e-commerce vendor to sell products and/or services provided by a second e-commerce vendor without the first vendor establishing a direct business relationship with the second e-commerce vendor, such as a reseller agreement or an affiliate-seller agreement. In the embodiments, when an online customer is shopping via an e-commerce sales mechanism for a first vendor, such as a shopping application or a website associated with the first vendor, a third-party e-commerce facilitator provides purchasing recommendations to the online customer for products and/or services provided by the second vendor. Further, the online customer completes purchases of products and/or services provided by the second vendor via a checkout process in the e-commerce sales mechanism for the first vendor. Thus, the purchase of products and/or services that are fulfilled by the second vendor is completed as part of the first vendor's checkout process and without redirecting the online customer to a different website or opening a different shopping application. As a result, recommendations for and purchases of the second vendor's products and/or services are performed through an on-going interaction between the online customer and the first vendor.

In some embodiments, the third-party e-commerce facilitator provides purchasing recommendations to the online customer based on information that is not available to the primary vendor and/or the secondary vendor(s). By leveraging customer behavioral and purchasing information collected from a large number of previous online purchases from primary and secondary vendors, the third-party e-commerce facilitator can generate higher-quality purchasing recommendations. Further, in some embodiments, the third-party e-commerce facilitator includes an artificial intelligence (AI) driven recommendation engine, which is well-suited to processing queries with a very large number of recommendation parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1A is a block diagram of an e-commerce system, according to various embodiments.

FIG. 1B is a more detailed block diagram of the e-commerce system of FIGS. 1A and 1B, according to various embodiments.

FIG. 2 is a flowchart illustrating the steps performed by an online customer during an online transaction, according to various embodiments.

FIG. 3 illustrates a graphical user interface that displays a window of an e-commerce sales mechanism, according to an embodiment.

FIG. 4 illustrates a graphical user interface displaying window of an e-commerce sales mechanism when modified with purchase recommendations, according to an embodiment.

FIG. 5 is an operational diagram illustrating certain steps of an online transaction performed within the e-commerce system of FIGS. 1A and 1B, according to various embodiments.

FIG. 6 is a block diagram of an e-commerce system, according to various embodiments.

FIG. 7 is an illustration of a computing device configured to perform various embodiments.

FIG. 8 is a block diagram of an illustrative embodiment of a computer program product for implementing one or more embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the disclosure, as generally described herein, and illustrated in the figures, can be arranged, substituted, combined, and designed in a wide variety of different configurations, all of which are explicitly contemplated and make part of this disclosure.

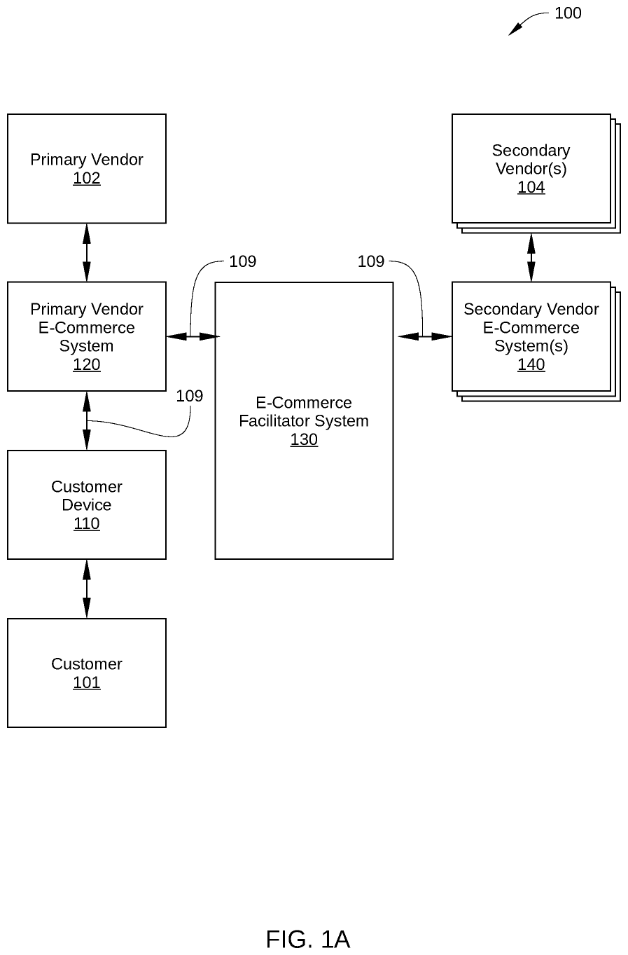

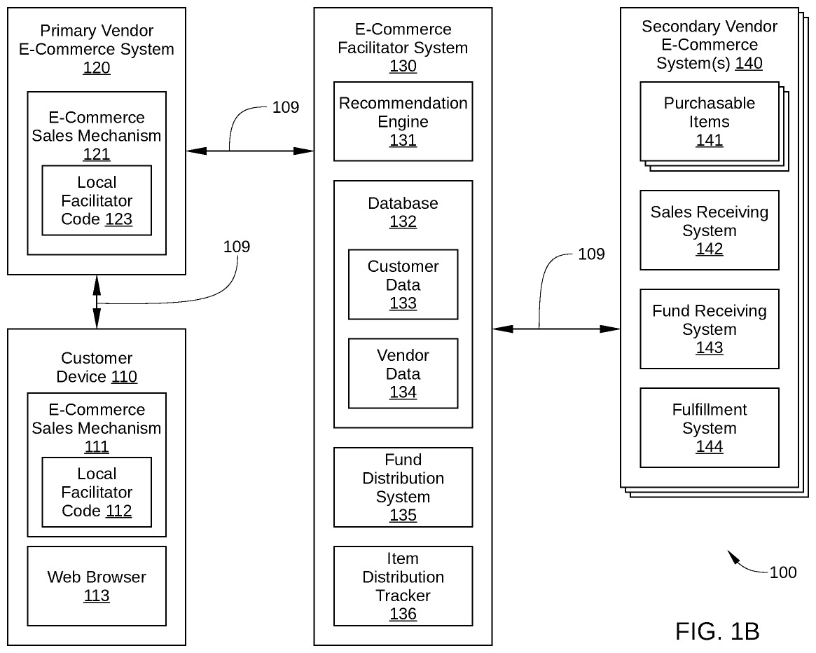

FIG. 1A is a block diagram of an e-commerce system 100, according to various embodiments of the present disclosure, and FIG. 1B is a more detailed block diagram of e-commerce system 100, according to various embodiments. As described below, e-commerce system 100 provides purchasing recommendations for products and/or services available from a secondary e-commerce vendor to an online customer who is interacting with an e-commerce sales mechanism associated with a primary e-commerce vendor. In addition, e-commerce system 100 enables the online customer to complete the purchase of such products and/or services without interrupting the current interaction. Thus, e-commerce system 100 does not redirecting the online customer to a website of the e-commerce vendor that actually provides the products and/or services. Instead, e-commerce system 100 enables the purchase of such products and/or services from the secondary e-commerce vendor as part of the checkout process for the primary vendor 102. Thus, e-commerce system 100 can acts as a reseller clearinghouse for e-commerce vendors that have no direct reseller agreements with each other and/or have no other knowledge of or communication with each other.

In the embodiment illustrated in FIGS. 1A and 1B, e-commerce system 100 includes a customer device 110 associated with a customer 101, a primary vendor e-commerce system 120 associated with a primary vendor 102, an e-commerce facilitator system 130, and one or more secondary vendor e-commerce systems 140 that are each associated with a respective secondary vendor 104. Customer 101 is an online shopper, and can be an individual consumer, business, or other entity capable of making an online purchase from primary vendor e-commerce system 120, for example with an electronic account number, such as a primary account number (PAN) of a credit card account, a gift card number, a digital wallet account number, and/or the like. Generally, customer 101 makes an online purchase from primary vendor e-commerce system 120 when customer device 110 is running an e-commerce sales mechanism 111 or is communicatively coupled to an e-commerce sales mechanism 121. Similarly, each of primary vendor 102 and secondary vendors 104 is an online merchant, such as an individual, sole proprietor, business, corporation, or other entity capable of making an online sale, for example with via a website connected to or an application running on customer device 110. In some embodiments, primary vendor 102 may be a vendor that is only capable of fulfilling online purchases through one or more secondary vendors 104 as described herein, and does not make products or services available to a customer 101 directly. In such embodiments, the selection and purchase of purchasable items are performed via primary vendor e-commerce system 120, even though the order for the purchasable items is fulfilled by one or more secondary vendors 104.

Primary vendor e-commerce system 120, e-commerce facilitator system 130, and/or secondary vendor e-commerce system(s) 140 can each be implemented as an individual computing device or server a plurality of computing devices or servers, or any other technically feasible computing system. For example, in some embodiments, primary vendor e-commerce system 120, e-commerce facilitator system 130, and/or secondary vendor e-commerce system(s) 140 can correspond to a physical computing system (e.g., a system in a data center) or may be a virtual computing instance executing within a computing cloud. Customer device 110, primary vendor e-commerce system 120, e-commerce facilitator system 130, and/or secondary vendor e-commerce system(s) 140 are communicatively coupled by one or more communication networks 109. The one or more communication networks 109 can each include a wireless local area network (WLAN), a cellular network, a wired communication network (such as a local area network), the Internet, or any combination thereof.

In some embodiments, a WLAN included in communication network(s) 109 enables compatible devices to connect to the Internet, either via a wired connection or a wireless access point, or “hotspot.” For example, in some embodiments, the WLAN is a WiFi network that includes one or more devices based on the Institute of Electrical and Electronics Engineers (IEEE) 802.11 standard. Thus, in such embodiments, any suitably configured wireless communication device that can connect to the WLAN, such as a smartphone or electronic tablet with WiFi capability, can perform data transfer to and from the Internet. Similarly, a cellular network included in the communication networks enables two-way wireless communication with wireless subscriber terminals, such as when user customer device 110 is configured as a smartphone.

Customer device 110 can be any technically feasible and network-connected computing device. For example, customer device 110 can be a desktop computer, laptop computer, smartphone, personal digital assistant (PDA), tablet computer, or any other type of computing device that is configured to receive input, process data, and display images, and is suitable for practicing one or more embodiments described herein. Thus, in some embodiments, customer device 110 is configured to execute an operating system (not shown), a web browser 113, an e-commerce sales mechanism 111 and/or other software applications. In addition, customer device 110 is configured to communicate with primary vendor e-commerce system 120, and, in some embodiments, e-commerce facilitator system 130, for example via a web browser 113 and/or e-commerce sales mechanism 111.

E-commerce sales mechanism 111 is a computer program designed to run on customer device 120. E-commerce sales mechanism 111 is loaded on customer device 110 and enables interactions with primary vendor e-commerce system 120, and, in some embodiments, e-commerce facilitator system 130, according to embodiments described herein. For example, in some embodiments, e-commerce sales mechanism 111 can be implemented as a web-application, an application that runs natively on customer device 110, or a hybrid application that can be downloaded and run locally by customer device 110. In embodiments in which customer device 110 communicates directly with e-commerce facilitator system 130, local facilitator code 112 enables such communications. In such embodiments, local facilitator code 112 may be a software development kit (SDK) that performs such functions. Alternatively, in such embodiments, local facilitator code 112 may be embedded as an iframe or JavaScript in e-commerce sales mechanism 111. Thus, in some embodiments, certain functions of and interactions between e-commerce facilitator 130 and e-commerce sale mechanism 111 can be embedded in the functionality of e-commerce sale mechanism 111. For example, in such embodiments, an electronic interface associated with a locally running application of primary vendor 102 can be modified via local facilitator code 112 to include purchase recommendations as described below.

Primary vendor e-commerce system 120 enables online transactions with a particular online or e-commerce merchant, referred to herein as a primary vendor 102. Generally, primary vendor e-commerce system 120 is an entity that is separate from and can be accessed by customer device 110 and e-commerce facilitator system 130 via communication network(s) 109. For example, in some embodiments, customer device 110 accesses primary vendor e-commerce system 120, such as a merchant website, via web browser 113 and/or e-commerce sales mechanism 111.

Primary vendor e-commerce system 120 can be implemented as a computing device, an application running on an instance of a virtual machine, and the like. For example, in some embodiments, primary vendor e-commerce system 120 can be a host computing device or web host service configured to provide access to and/or generate e-commerce sales mechanism 121 as a merchant website. Alternatively or additionally, in some embodiments, e-commerce sales mechanism 121 can be configured to be communicatively coupled to and interact with e-commerce sales mechanism 111 running on customer device 110. In either case, e-commerce sales mechanism 121 enables the display and sale of products and/or services (referred to herein as “purchasable items”) to online customers. For example, in some embodiments, user e-commerce sales mechanism 121 is connected to browser 113 of customer device 110 via web browser 113 in the course of online shopping. In such embodiments, a user can browse through various pages of the merchant website of e-commerce sales mechanism 121. In such embodiments, the web pages of e-commerce sales mechanism 121 display product information, enable a customer 101 to select a particular purchasable item or items (for example by adding that particular purchasable item to a digital checkout cart), and then purchase the particular purchasable item via an online transaction through e-commerce sales mechanism 121.

According to various embodiments, e-commerce sales mechanism 121 receives one or more purchase recommendations for a particular shopper from e-commerce facilitator system 130 and provides these purchase recommendations to the shopper. In the embodiments, these purchase recommendations include at least one purchasable item that is not available from primary vendor 102 and is available from a secondary vendor 104 associated with secondary vendor e-commerce system 140. According to the various embodiments, secondary vendor 104 has no direct business relationship with primary vendor 102, such as a reseller agreement or an affiliate-seller agreement. Thus, primary vendor 102 is not a reseller or affiliate seller for secondary vendor(s) 104 and vice-versa. Further, in some embodiments, primary vendor 102 has no knowledge of purchasable items available from secondary vendor 104. In some embodiments, the interactions described herein between primary vendor e-commerce system 120 and e-commerce facilitator system 130 are enabled by local facilitator code 123. In such embodiments, local facilitator code 123 may be an SDK that enables such interactions. Alternatively, in such embodiments, local facilitator code 132 may be embedded as an iframe or JavaScript in e-commerce sales mechanism 121. Thus, in some embodiments, certain functions of and interactions between e-commerce facilitator 130 and e-commerce sale mechanism 121 can be embedded in the functionality of e-commerce sale mechanism 121. For example, in such embodiments, an electronic interface associated with a website of primary vendor 102 can be modified via local facilitator code 123 to include purchase recommendations as described below.

E-commerce facilitator system 130 can be implemented as a computing device, an application running on an instance of a virtual machine, and the like. In the embodiment illustrated in FIGS. 1A and 1B, e-commerce facilitator system 130 is communicatively coupled to and interacts with e-commerce sales mechanism 111 running on customer device 110 and one or more secondary vendor e-commerce systems 140. According to various embodiments, e-commerce facilitator system 130 enables an online customer 101 associated with customer device 110 to purchase purchasable items from a secondary e-commerce vendor as part of the checkout process for primary vendor 102. In the embodiment illustrated in FIGS. 1A and 1B, e-commerce facilitator system 130 includes a recommendation engine 131, a database 132, a fund distribution system 135, and an item distribution tracker 136.

It is noted that e-commerce system 100 operates as described herein even though secondary vendor 104 has no direct business relationship in place with primary vendor 102, and primary vendor 102 may have no access to the information associated with purchasable items available from secondary vendor 104. Thus, in e-commerce system 100, there is no agreement in place between primary vendor and secondary vendor 104 that allows primary vendor 102 to recommend, initiate, and/or complete the sale of products from secondary vendor 104. Examples of direct business relationships that are conventionally employed to enable one merchant or vendor to sell to sell a product or service of another merchant or vendor include: an affiliate-seller agreement, an agency agreement, a reseller agreement, and/or a distributor (or distribution) agreement. In an affiliate-seller agreement, an affiliate seller or vendor promotes products or services that are provided by a different company or vendor. Thus, in e-commerce, an affiliate seller or vendor typically earns a commission for each sale or lead that is generated through an affiliate link, where the affiliate link is provided to an online customer by the affiliate seller or vendor, for example via a website, email, or other electronic means. In an agency agreement, which can be similar to an affiliate-seller agreement, a fiduciary relationship is created between a principal and an agent, whereby the principal agrees to be bound by actions of the agent, such as sales of products or services by the agent. Thus, under such an agreement, the agent can sell products or services that are not actually owned or provided by the agent. A reseller agreement is a contractual arrangement between a supplier (e.g., a vendor or wholesaler) and another party (e.g., an online vendor) that agrees to sell products on behalf of the supplier. A reseller agreement is typically a legally binding agreement that outlines the respective responsibilities of the supplier and the online vendor, including product pricing, quantity limits, sales strategies, and the like. Thus, for the reseller to sell the products or services of the supplier, a direct legal and business relationship is first established between the supplier and the reseller via the reseller agreement. Typically, under a reseller agreement, the reseller actually owns the product being sold. In a distributor (or distribution) agreement, which can be similar to a reseller agreement, a contract is established between a first party or company (the supplier) with products to sell and a second party or company (the distributor) that markets and sells the products or services. For example, under such an agreement, a distributor may agree to buy products from the supplier and sell the products to customers within a certain geographical area. Typically, under a distributor agreement, the distributor actually owns the products being sold. According to embodiments described herein, an e-commerce system 100 enables online customer 101 to purchase, from primary vendor 102, products or services that are fulfilled by secondary vendor 104, even though secondary vendor 104 has no direct business relationship in place with primary vendor 102.

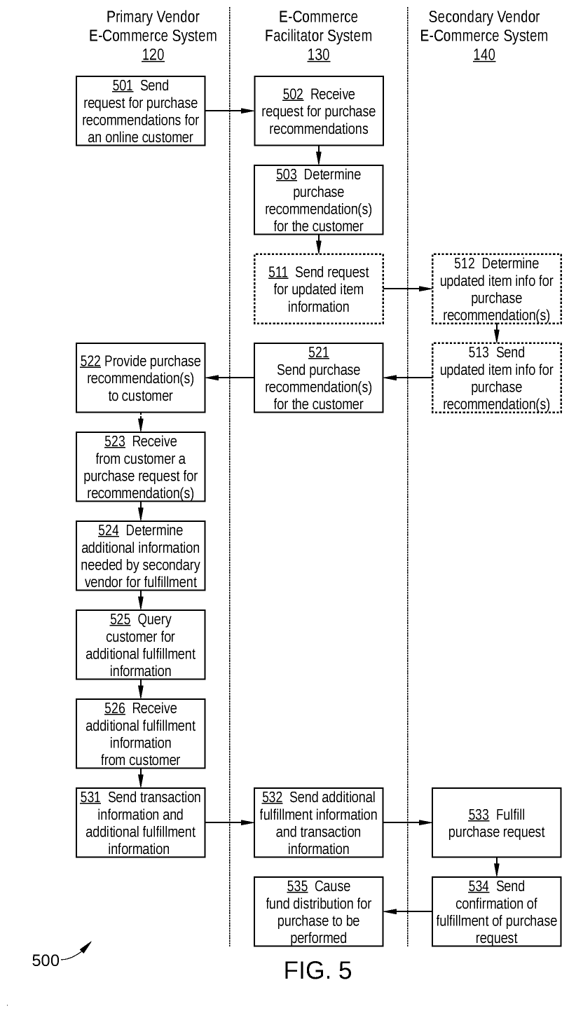

Recommendation engine 131 determines purchase recommendations for a particular online customer 101 that is interacting with e-commerce primary vendor system 120. Generally, recommendation engine 131 determines one or more purchase recommendations in response to receiving a request for one or more purchase recommendations from e-commerce sales mechanism 121 (or in some embodiment from e-commerce sales mechanism 111), where the purchase recommendation(s) include at least one purchasable item that is not available from primary vendor 102 and is available from a secondary vendor 104. As described in greater detail below in conjunction with FIG. 5, recommendation engine 131 determines purchase recommendations for a particular online customer 101 based on various factors associated with online customer 101, primary vendor 102, and/or secondary vendors 104.

Recommendation engine 131 can determine purchase recommendations for a particular online customer 101 using one or more conventional search algorithms, rules-based algorithms, and/or data filtering systems. Such algorithms and systems may employ behavioral and/or historical data associated with a particular online customer 101, computer learning, and/or statistical modeling to generate one or more purchase recommendations that are likely to be selected by that particular online customer 101. In some embodiments, recommendation engine 131 includes or is based on an artificial intelligence and/or machine-learning model.

Database 132 includes information that enables recommendation engine 131 to determine purchase recommendations when an online customer 101 is interacting with e-commerce primary vendor system 120. Database 132 also includes information that enables e-commerce facilitator 130 to facilitate purchase and receipt of purchasable items that are available from secondary vendor 104 but purchased through primary vendor 102.

In the embodiment illustrated in FIGS. 1A and 1B, database 132 includes customer data 133 and vendor data 134. Customer data 133 includes information for specific online customers 101, such as online customers who have previously interacted with e-commerce system 100. For example, such online customers can include online customers who have purchased one or more items from primary vendor 102 (e.g., via primary vendor e-commerce system 120) and/or one or more secondary vendors 104. In some embodiments, customer data 133 includes, for such online customers, personally identifiable information (PII), shipping information, billing information, purchasing history information (including item prices, sizes, colors, etc.), specific key words associated with the online customer, merchant ratings of particular customers, and/or the like. Vendor data 134 includes information for primary vendor 102 and the plurality of secondary inventors 104 included in e-commerce system 100. For example, vendor data 134 can include, for primary vendor 102 and secondary vendors 104, a vendor category or categories, a customer rating of the vendor, a vendor location, purchasable items available from each vendor, vendor-specific requirements for order-completion information, and/or the like.

Fund distribution system 135 handles and/or tracks distribution of funds for purchases completed via primary vendor e-commerce system 120. In some embodiments, when online customer 101 completes an online purchase for a purchasable item from a secondary vendor 104 via primary vendor e-commerce system 120, fund distribution system 135 performs actions to ensure funds associated with the completed purchase are correctly distributed. In some embodiments, fund distribution system 135 generates multiple requests for payment settlement associated with the online purchase and transmits the multiple requests to a suitable payment processor. For example, in one such embodiment, fund distribution system 135 transmits a first request to the payment processor for a first payment settlement and a second request to the payment processor for a second payment settlement. In such an embodiment, the first request is for the transfer of a first portion of funds from an account associated with online customer 101 to a bank account associated with the first vendor (for example as a referral fee), and the second request is for the transfer of a second portion of funds from the account associated with online customer 101 to a bank account associated with the second vendor (for example to pay for the purchasable item). In another such embodiment, fund distribution system 135 transmits the above-described first request and second request to the payment processor as well as a third request for a third payment settlement. In such an embodiment, the third request is for the transfer of a third portion of funds from the account associated with online customer 101 to a bank account associated with e-commerce facilitator system 130 (for example as a processing fee).

In the above-described embodiment of fund distribution system 135, fund distribution system 135 transmits requests for payment settlements directly to a suitable payment processor. Thus, in such embodiments, the functions of fund distribution system 135 can be integrated into a payment gateway or other transaction-authorizing entity for online transactions. In other embodiments, fund distribution system 135 transmits requests for payment settlement to a payment gateway or other transaction-authorizing entity for online transactions.

Item distribution tracker 136 handles and/or tracks distribution of purchasable item(s) for purchases completed via primary vendor e-commerce system 120. In some embodiments, when online customer 101 completes an online purchase for a purchasable item from a secondary vendor 104 via primary vendor e-commerce system 120, item distribution tracker 136 performs actions to ensure the purchasable item(s) associated with the completed purchase are correctly distributed. In some embodiments, item distribution tracker 136 receives order-completion information (such as shipping information associated with online customer 101) from primary vendor e-commerce system 120 and transfers such information to secondary vendor e-commerce system 140.

In some embodiments, item distribution tracker 136 enables secondary vendor 104 to fulfill the online purchase of the purchasable item even though primary vendor 102 generally has no relationship with secondary vendor 104. For example, in some instances, order-completion information requested by e-commerce sales mechanism 111 or e-commerce sales mechanism 121 may not include all information needed by secondary vendor e-commerce system 140 to complete fulfillment of the online purchase. In some embodiments, for a particular purchase recommendation generated by recommendation engine 131, item distribution tracker 136 determines the additional fulfillment information needed by secondary vendor 104 to fulfill the particular purchase recommendation and notifies primary vendor e-commerce system 120 of the additional fulfillment information needed when providing that particular purchase recommendation to primary vendor e-commerce system 120. For example, in such embodiments, item distribution tracker 136 can determine the additional fulfillment information needed by secondary vendor 104 by comparing the vendor-specific requirements associated with secondary vendor 104 for order-completion information to the vendor-specific information for order-completion requirements associated with primary vendor 102. Alternatively, in some embodiments, item distribution tracker 136 determines the additional fulfillment information needed by secondary vendor 104 for a particular online purchase of a recommended purchasable item and notifies primary vendor e-commerce system 120 of the additional fulfillment information needed when online customer 101 purchases the recommended purchasable item. In such embodiments, item distribution tracker 136 can determine the additional fulfillment information needed by secondary vendor 104 by comparing the vendor-specific requirements associated with secondary vendor 104 to order-completion information received from primary vendor e-commerce system 120.

Secondary vendor e-commerce system 140 enables online transactions with a particular online or e-commerce merchant, referred to herein as a secondary vendor 104. Generally, secondary vendor e-commerce system 140 is an entity that is separate from and can be accessed by e-commerce facilitator system 130 via communication network(s) 109. Secondary vendor e-commerce system 140 can be implemented as a computing device, an application running on an instance of a virtual machine, and the like. Generally, secondary vendor e-commerce system 140 is configured to fulfill the online purchase of purchasable items 151 (products and/or services) by online customers. For example, in some embodiments, secondary vendor e-commerce system 140 can include a host computing device or web host service configured to receive notification that an online purchase of a purchasable item 141 has been completed and to fulfill the online purchase. Examples of purchasable items 141 include physical products, software or other digital products, and/or services. In the embodiment illustrated in FIGS. 1A and 1B, secondary vendor e-commerce system 140 includes purchasable items 141, a sales receiving system 142, a fund receiving system 143, and a fulfillment system 144.

Sales receiving system 142 can be any system enabling receipt of notifications from e-commerce facilitator system 130 indicating that an online purchase of one or more purchasable items 141 has been completed. Sales receiving system 142 is further configured to notify fulfillment system 144 of such completed online purchases. In some embodiments, sales receiving system 142 is a fully automated system. For example, in an embodiment, electronically received notifications from e-commerce facilitator system 130 are automatically forwarded to a computing device associated with fulfillment system 144. Alternatively, in some embodiments, sales receiving system 142 can include human intervention. For example, in an embodiment, notifications from e-commerce facilitator system 130 can be received electronically via an email system that is periodically checked by a user for such notifications. In such embodiments, the notification may be manually or electronically forwarded to fulfillment system 144.

In some embodiments, sales receiving system 142 is further configured to receive requests for updated item information for specific purchasable items 141. For example, in some embodiments, when purchasable items 141 are to be included in a purchase recommendation for an online customer 101 interacting with primary vendor e-commerce system 120, sales receiving system 142 receives a request for updated item information from e-commerce facilitator system 130. In some embodiments, such updated item information includes inventory information, availability information, pricing information, shipping time estimates, and the like.

Fund receiving system 143 can be any system enabling receipt of funds for an online purchase completed via primary vendor e-commerce system 120. For example, in some embodiments, fund receiving system 143 includes a bank account or other means of electronically receiving funds from a payment processor.

Fulfillment system 144 can be any system enabling fulfillment of an online purchase completed via primary vendor e-commerce system 120 for a purchasable item provided by secondary vendor 104. For example, in some embodiments, fulfillment system 144 includes one or more warehouses or other hubs for performing an order fulfillment process. Thus, fulfillment system 144 enables the logistical steps needed for secondary vendor 104 to provide a purchasable item to online customer 101 who completed the purchase of the purchasable item. In some embodiments, fulfillment system 144 may include physical storage, packing, and shipping facilities. In embodiments in which secondary vendor 104 provides software and/or other digital products, fulfillment system 144 can include servers or other computing devices for provisioning the digital products to the online customer 101.

In the embodiment illustrated in FIGS. 1A and 1B, primary vendor e-commerce system 120, which is associated with primary vendor 102, interacts directly with customer device 110, while one or more secondary vendor e-commerce systems 140, which are associated with various secondary vendors 104, fulfill purchases made by a customer 101 associated with customer device 110. In practice, primary vendor 102 can also act as a secondary vendor 104 in e-commerce system 100 for one or more of secondary vendors 104, and each of secondary vendors 104 can act as a primary vendor 102 in e-commerce system 100. Consequently, primary vendor 102 can be associated with a herein-described secondary vendor e-commerce system 140, and each of secondary vendor(s) 104 can be associated with a herein-described primary vendor e-commerce system 120.

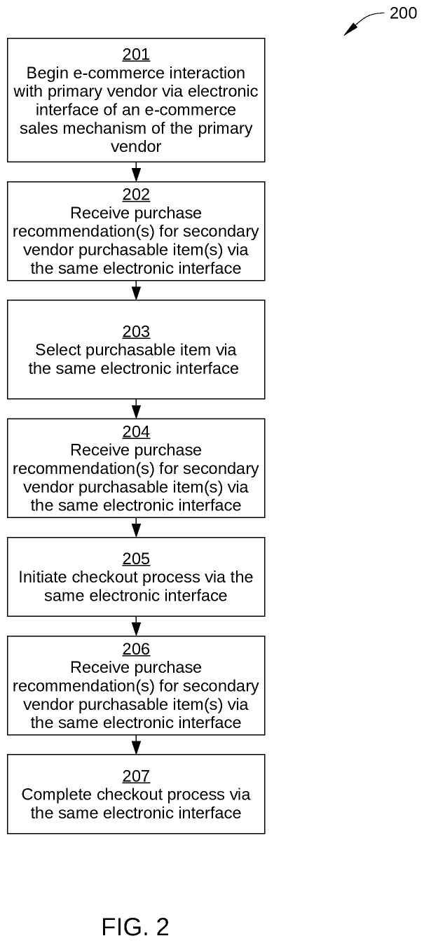

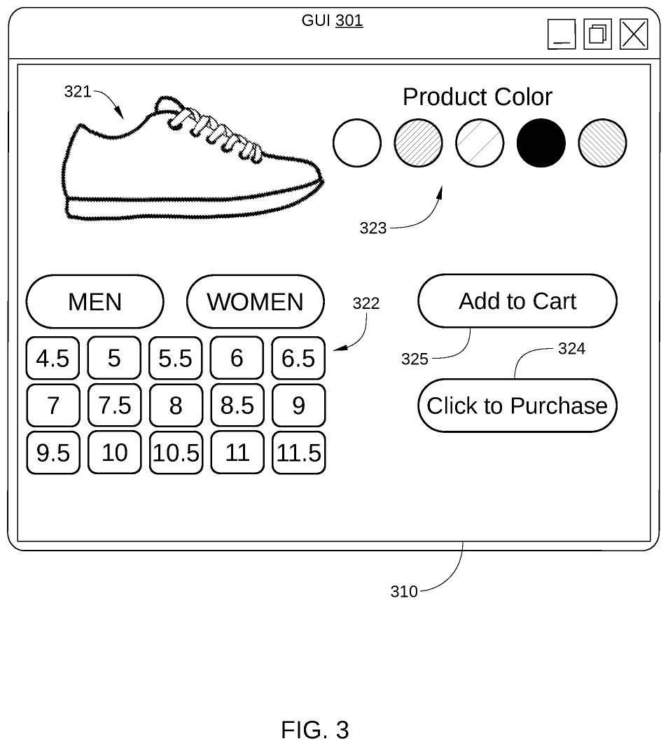

FIG. 2 is a flowchart illustrating steps 200 performed by an online customer during an online transaction, according to various embodiments. For example, steps 200 may be performed when the online customer, such as customer 101 in FIG. 1A, initiates an online interaction with a primary vendor of e-commerce system 100. In some embodiments, the online interaction begins at step 201, where the online customer connects to e-commerce sales mechanism 121, such as a merchant website associated with primary vendor 102. Alternatively, the online interaction begins when the online customer opens e-commerce sales mechanism 111 on customer device 110, such as an application that runs natively on customer device 110. In either case, the interaction is performed via an electronic interface of the e-commerce sales mechanism. One embodiment of an electronic interface of an e-commerce sales mechanism associated with primary vendor 102 is described below in conjunction with FIG. 3.

FIG. 3 illustrates a graphical user interface (GUI) 301 that displays a window 310 of an e-commerce sales mechanism, according to an embodiment. In the embodiment illustrated in FIG. 3, the e-commerce sales mechanism is implemented as a merchant website and GUI 301 is implemented as a web page. In other embodiments, the e-commerce sales mechanism can be implemented as a software application running on customer device 110 and GUI 301 is implemented as a window or tab of the software application. Window 310 displays item information associated with one or more specific products or services available from primary vendor 102. In the embodiment illustrated in FIG. 3, the item information displayed includes an image 321 of a particular product, available sizes 322 of the particular product, a menu 323 of available colors, a transaction button 324, an add-to-cart button 325, and the like. According to various embodiments, window 310 may be updated to display one or more purchase recommendations received from e-commerce facilitator system 130, as described below.

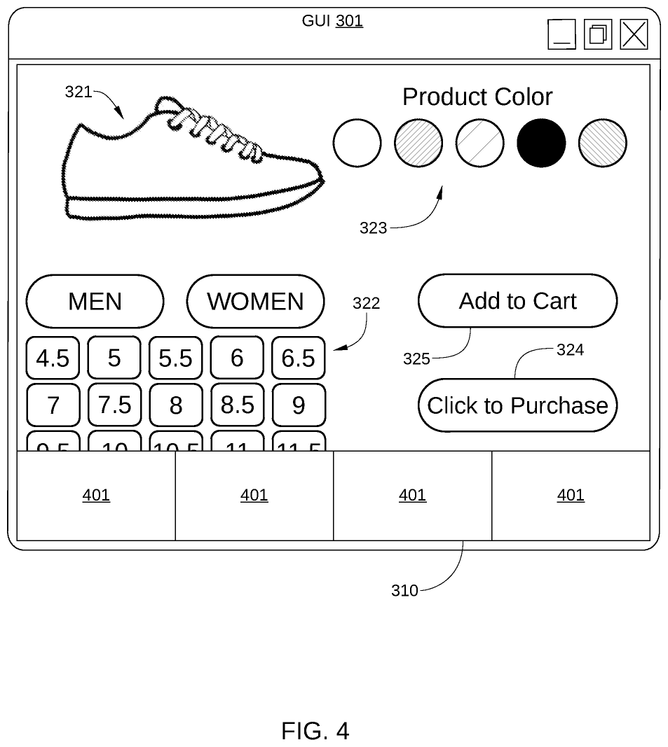

Returning to FIG. 2, in step 202, one or more purchase recommendations may be provided to the online customer via the electronic interface of the e-commerce sales mechanism of primary vendor e-commerce system 120. In some embodiments, the one or more purchase recommendations are provided to the online customer via the electronic interface in response to the online customer beginning the interaction with primary vendor e-commerce system 120. In such embodiments, the online customer may be identified and/or certain customer information may be inferred when the online customer begins the interaction. In this way, recommendation engine 131 can generate one or more purchase recommendations before the online customer has actively entered information such as search terms and the like. For example, in some embodiments, based on the online customer signing into a merchant website associated with primary vendor 102, primary vendor e-commerce system 120 can provide recommendation engine 131 with customer information that enables recommendation engine 131 to generate the one or more purchase recommendations. In another example embodiment, based on an Internet Protocol (IP) address associated with customer device 120, primary vendor e-commerce system 120 can provide recommendation engine 131 with customer information that enables recommendation engine 131 to generate the one or more purchase recommendations. In some embodiments, the one or more purchase recommendations are provided to the online customer via a modification of the electronic interface of the e-commerce sales mechanism of primary vendor e-commerce system 120. One such embodiment is described below in conjunction with FIG. 4.

FIG. 4 illustrates GUI 301 displaying window 310 of an e-commerce sales mechanism when modified with purchase recommendations 401, according to an embodiment. In the embodiment illustrated in FIG. 4, purchase recommendations 401 are added to content that is a displayed within window 310.

Returning to FIG. 2, in step 203, the online user selects one or more purchasable items via the electronic interface of the e-commerce sales mechanism of primary vendor e-commerce system 120, such as window 310. The selected purchasable items may be a purchasable item available from primary vendor 102 or one of the one or more purchase recommendations 401 displayed in the electronic interface in step 203. For example, in an embodiment, the online user views a particular purchasable item via the electronic interface and then selects an associated add-to-cart button 325 in a product window provided for that particular purchasable item.

In step 204, one or more purchase recommendations may be provided to the online customer via the electronic interface of the e-commerce sales mechanism of primary vendor e-commerce system 120. In such embodiments, the one or more purchase recommendations are provided to the online customer via the electronic interface in response to the online customer selecting the purchasable item in step 203 for purchase during the interaction with primary vendor e-commerce system 120. In such embodiments, primary vendor e-commerce system 120 can provide recommendation engine 131 with customer cart information and/or searching information associated with the online customer that enables recommendation engine 131 to generate the one or more purchase recommendations for that online customer. In this way, recommendation engine 131 generates one or more purchase recommendations in response to the online customer making specific cart selections and/or performing one or more searches.

In step 205, the online user initiates a checkout process via the electronic interface of the e-commerce sales mechanism of primary vendor e-commerce system 120. For example, in an embodiment, the online user selects a transaction button 324 included in the electronic interface, such as a go-to-cart button, a buy-now button, and the like.

In step 206, one or more purchase recommendations may be provided to the online customer via the electronic interface of the e-commerce sales mechanism of primary vendor e-commerce system 120. In such embodiments, the one or more purchase recommendations are provided to the online customer via the electronic interface in response to the online customer initiating the checkout process during the interaction with primary vendor e-commerce system 120. In such embodiments, primary vendor e-commerce system 120 can provide recommendation engine 131 with customer purchasing information associated with the online customer that enables recommendation engine 131 to generate the one or more purchase recommendations for that online customer. In this way, recommendation engine 131 generates one or more purchase recommendations in response to the online customer making specific purchasing selections.

In step 207, the online customer completes the checkout process via the electronic interface of the e-commerce sales mechanism of primary vendor e-commerce system 120. For example, in some embodiments, the online customer completes the checkout process by providing shipping and/or payment information to primary vendor e-commerce system 120. In some embodiments, prompts are provided for vendor-specific order-completion information required by a secondary vendor 104 to fulfill the purchase of a purchasable item. As noted previously, such prompts can be provided to primary vendor e-commerce system 120 by item distribution tracker 136 or some other function of e-commerce facilitator system 130.

FIG. 5 is an operational diagram illustrating certain steps of an online transaction 500 performed within e-commerce system 100, according to various embodiments. In some embodiments, online transaction 500 is performed by e-commerce system 100 during interactions between customer device 110, which is associated with an online customer, such as customer 101. Online transaction 500 may include one or more operations, functions, or actions as illustrated by one or more of blocks 501-535. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with e-commerce system 100 of FIGS. 1A and 1B, persons skilled in the art will understand that within the scope of the present disclosure an online customer can perform online transaction 500 in conjunction with any suitably configured system.

Online transaction 500 begins at step 501, where primary vendor e-commerce system 120 sends a request for purchase recommendations for customer 101. In some embodiments, the request is sent in response to customer 101 beginning the interaction with primary vendor e-commerce system 120, customer 101 selecting a purchasable item for purchase during the interaction with primary vendor e-commerce system 120, and/or in response to customer 101 initiating or completing the checkout process during the interaction with primary vendor e-commerce system 120.

In step 502, e-commerce facilitator system 130 receives the request for purchase recommendations from primary vendor e-commerce system 120. In step 503, e-commerce facilitator system 130 determines one or more purchase recommendations for customer 101. In addition, in some embodiments, e-commerce facilitator system 130 saves in database 132 information included in the request for purchase recommendations received in step 502. Such information saved in database 132 can be employed by recommendation engine 131 for future purchase recommendations. Recommendation engine 131 determines the one or more purchase recommendations for customer 101 based on various factors as described below.

In some embodiments, recommendation engine 131 determines the one or more purchase recommendations based at least in part on information included in the request for the purchase recommendation(s). In some embodiments, such information includes one or more of customer-identifying information, order information for customer 101 related to primary vendor 102 (such as purchase history with primary vendor 102 and/or current cart contents that are provided by primary vendor 102), order information for customer 101 associated with secondary vendor 104 (such as current cart contents that are provided by secondary vendor 104), customer browsing information associated with primary vendor 102, and the like.

In some embodiments, recommendation engine 131 determines the one or more purchase recommendations based at least in part on customer information associated with a secondary vendor 104. For example, such customer information can be information that is included in database 132 that is linked to customer 101 and/or the secondary vendor 104, such as previous purchases from the secondary vendor 104 by the online customer. Thus, in such embodiments, recommendation engine 131 can determine purchase recommendations for customer 101 based on information that is not available to primary vendor 102.

In some embodiments, recommendation engine 131 determines the one or more purchase recommendations based at least in part on a previously defined recommendation preference received from primary vendor 102. For example, in some embodiments, a recommendation preference received from primary vendor 102 may include categories of secondary vendors 104 whose purchasable items are not to be considered as a purchase recommendation. Such categories of secondary inventors may include secondary vendors 104 that are direct competitors of primary vendor 102, secondary vendors 104 that are located in a specified geographical area, secondary vendors 104 that have a customer rating below a specified threshold, secondary vendors 104 that sell a specified type of items, such as gambling services, adult-themed services, products that are not locally produced, specific e-commerce vendors proscribed by primary vendor 102 from being considered, and/or the like. Alternatively or additionally, in some embodiments, a recommendation preference received from primary vendor 102 may include secondary vendors 104 whose purchasable items are to be considered as a purchase recommendation. Alternatively or additionally, in some embodiments, a recommendation preference received from primary vendor 102 may include categories of purchasable items that are not to be considered as a purchase recommendation, such as purchasable items having a buyer rating that is below a specified threshold, purchasable items that have a price above or below a specified threshold, purchasable items made in a specified country, purchasable items containing specified materials, and/or the like.

In some embodiments, recommendation engine 131 determines the one or more purchase recommendations based at least in part on a previously defined recommendation preference received from one or more secondary vendors 104. In some embodiments, a recommendation preference of a particular secondary vendor 104 may include a first category of primary vendors 102 that are eligible to resell purchasable items from that particular secondary vendor 104 and a second category of primary vendors 102 that are not eligible to resell purchasable items from that particular secondary vendor 104. Alternatively or additionally, in some embodiments, a recommendation preference received from a particular secondary vendor 104 may include customers having a merchant rating that is below a specified threshold are not to be offered purchasable items from that particular secondary vendor 104 as a purchase recommendation, purchasable items from that particular secondary vendor 104 that have a price above or below a specified threshold are (or are not) to be offered as a purchase recommendation, customers located in a specified country are not to be offered purchasable items from that particular secondary vendor 104 as a purchase recommendation, and/or the like.

In some embodiments, recommendation engine 131 determines the one or more purchase recommendations based at least in part on a previous purchase behavior of customer 101 with primary vendor 102, with one or more secondary vendors 104, and/or other e-commerce vendors (such as an e-commerce vendor that is neither primary vendor 102 nor secondary vendor 104). Such information can include specific secondary vendors 104 from which customer 101 has purchased a purchasable item and/or selected a purchasable item for purchase (i.e., placed in a checkout cart), categories of secondary vendors 104 from which customer 101 has purchased a purchasable item and/or selected a purchasable item for purchase, specific purchasable items customer 101 has purchased and/or selected for purchase, categories of purchasable items customer 101 has purchased and/or selected for purchase, price ranges of purchasable items customer 101 has purchased and/or selected for purchase, and the like. In such embodiments, information related to the previous purchase behavior can be stored in customer data 133. Thus, in such embodiments, recommendation engine 131 can determine purchase recommendations for customer 101 based on information that is not available to primary vendor 102.

In some embodiments, optional steps 511-513 are performed as part of online transaction 500 so that updated item information (such as inventory information, availability information, pricing information, shipping time estimates, and the like) is included with purchase recommendations when the purchase recommendations are provided to primary vendor e-commerce system 120. In optional step 511, e-commerce facilitator system 130 sends a request for updated item information to secondary vendor e-commerce system 140, where the request is based on one or more purchase recommendations for items that are provided by secondary vendor 104. In optional step 512, secondary vendor e-commerce system 140 receives the request and determines the updated item information for the one or more purchase recommendations. In optional step 513, secondary vendor e-commerce system 140 sends the updated item information to e-commerce facilitator system 130.

In step 521, e-commerce facilitator system 130 sends purchase recommendations for a particular customer 101 to primary vendor e-commerce system 120. It is noted that, in some embodiments, such purchase recommendations may include the updated item information determined in step 512. In step 522, primary vendor e-commerce system 120 provides the purchase recommendation(s) to customer 101, for example by modifying an output of an electronic interface displayed by customer device 110. In step 523, primary vendor e-commerce system 120 receives a purchase request for one or more items that are included in the purchase recommendation(s) received in step 522. For example, in an embodiment, primary vendor e-commerce system 120 receives the purchase request from an input by customer 101 via the electronic interface associated with primary vendor e-commerce system 120. In step 524, additional fulfillment information needed by secondary vendor 104 for fulfillment of the purchase request is determined. In some embodiments, local facilitator code 112 in e-commerce sales mechanism 111 determines the additional fulfillment information, for example by communicating with item distribution tracker 136 of e-commerce facilitator system 130. Alternatively, in some embodiments, item distribution tracker 136 determines the additional fulfillment information and communicates with either local facilitator code 112 in e-commerce sales mechanism 111 or local facilitator code 123 in e-commerce sales mechanism 121. In step 525, primary vendor e-commerce system 120 queries customer 101 for the additional fulfillment information, for example via the electronic interface associated with primary vendor e-commerce system 120. In step 526, primary vendor e-commerce system 120 receives the additional fulfillment information from customer 101, for example via the electronic interface associated with primary vendor e-commerce system 120.

In step 531, primary vendor e-commerce system 120 sends transaction information and the additional fulfillment information to e-commerce facilitator system 130. In some embodiments, the transaction information includes information primary vendor 102 requests for completion of the purchase, such as customer shipping information, customer billing information, and the like. In addition, in some embodiments, the transaction information includes an indication that one or more items included in the purchase request received in step 523 are to be purchased by customer 101, and therefore fulfilled by secondary vendor 104. In step 532, e-commerce facilitator system 130 sends the purchase request to secondary vendor e-commerce system 140. In some embodiments, the purchase request includes the transaction information and the additional fulfillment information provided to e-commerce facilitator system 130 by primary vendor e-commerce system 120. In addition, in some embodiments, e-commerce facilitator system 130 saves in database 132 information included in the transaction information and/or the additional information received in step 502. Such information saved in database 132 can be employed by recommendation engine 131 for future purchase recommendations. In step 533, secondary vendor e-commerce system 140 receives the transaction information and the additional fulfillment information. Thus, secondary vendor 104 receives both additional purchases via e-commerce facilitator 130 and customer information that can be employed to expand the customer base of secondary vendor 104. In step 533, secondary vendor e-commerce system 140 also fulfills the purchase request, for example via fulfillment system 144. In step 534, secondary vendor e-commerce system 140 sends confirmation of fulfillment of the purchase request to e-commerce facilitator system 130, for example via item distribution tracker 136.

In step 535, e-commerce facilitator system 130 causes fund distribution for the fulfilled purchase to be performed. For example, in some embodiments, fund distribution system 135 transmits requests to a payment processor for appropriate payment settlements between an account associated with customer 101 and accounts associated with primary vendor 102, secondary vendor 104, and, in some embodiments, e-commerce facilitator system 130. Such accounts can include a bank account, a credit card account, a gift card number, a digital wallet account number, and/or the like. In one embodiment, fund distribution system 135 transmits a first request to a payment processor for a first payment settlement from an account associated with customer 101 (such as a credit card account) to an account associated with primary vendor 102 (such as a bank account) and a second request to the payment processor for a second payment settlement from the account associated with customer 101 to an account associated with secondary vendor 104 (such as a bank account). In another embodiment, fund distribution system 135 transmits the above-described first request and second request to the payment processor as well as a third request for a third payment settlement from the account associated with customer 101 to an account associated with the e-commerce facilitator system 130 (such as a bank account).

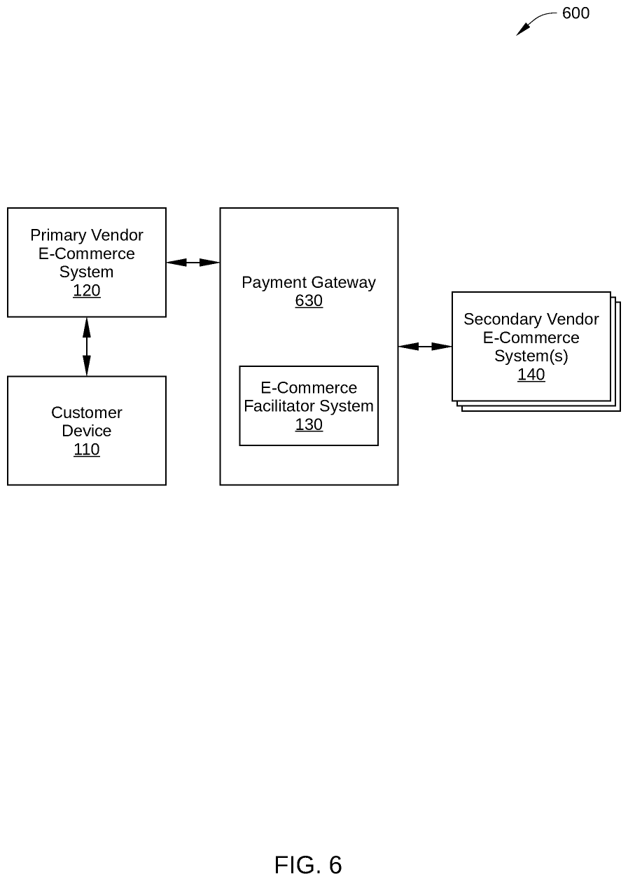

FIG. 6 is a block diagram of an e-commerce system 600, according to various embodiments. In the above-described embodiments, e-commerce facilitator system 130 performs certain functions similar to a payment processor. For example, in such embodiments, fund distribution system 135 handles and/or tracks distribution of funds for purchases completed via primary vendor e-commerce system 120. By contrast, in the embodiment of e-commerce system 600 illustrated in FIG. 6, some or all of the herein-described functions of e-commerce facilitator system 130 are incorporated into a payment gateway 630. For example, in such embodiments, local facilitator code 123 is embedded in e-commerce sale mechanism 121 along with embedded payment code that is provided by payment gateway 630 to primary vendor e-commerce system 120.

### First Use Case

In an example first use case, e-commerce sales mechanism 121 is implemented as a website that is dedicated to a particular subject or area of interest, such as a hobby, sports team, topic of natural history, etc. In the first use case, primary vendor 102 is the owner, operator, and/or manager of the website, and does not directly sell any products or services (e.g., purchasable items 141). Therefore, primary vendor 102 maintains no product inventory and provides no services, and does not fulfill orders for purchasable items ordered by customer 101 via the website. Instead, e-commerce facilitator system 130 provides purchasing suggestions to potential customers 101 when visiting the website of primary vendor 102. For example, such purchasing suggestions may be related to the particular area of interest of the website and/or may include commonly purchased items by persons associated with the particular area of interest of the website. Further, e-commerce facilitator system 130 enables purchases of such purchasing suggestions by customer 101 through the website. For example, in some embodiments, local facilitator code 123 is embedded in the website to enable interactions between e-commerce facilitator 130 and e-commerce sale mechanism 121 as described above. Thus, in such embodiments, e-commerce facilitator 130 enhances the functionality of e-commerce sale mechanism 121 so that the selection process for a suggested purchasable item and/or the checkout process is integrated into the website and customer 101 is not directed to a website of a third-party (e.g., of secondary vendor 104) to complete the selection and/or checkout processes.

In the first use case, primary vendor 102 beneficially receives additional revenue from sales to secondary vendor(s) 104. However, unlike an online merchant that has an affiliate-seller agreement with one or more secondary vendors 104, purchases are made through the website of primary vendor 102, and customer 101 is not redirected to a website of a secondary vendor 104 for example via an affiliate link. Thus, the interaction between customer 101 and primary vendor 102 is not interrupted, and primary vendor 102 does not suffer the loss of web traffic or engagement (which is highly undesirable). In addition, primary vendor 102 receives the additional revenue for online sales without being subject to the costs of maintaining physical inventory and an order fulfillment system.

A secondary vendor 104 beneficially receives additional revenue from orders completed via the website of primary vendor 102, even though there may be no direct business relationship between primary vendor 102 and secondary vendor 104 (such as an affiliate-seller agreement and/or a reseller agreement). In addition, secondary vendor 104 gains new customers and customer information as a result of each sale through the website of primary vendor 102. Because customer acquisition is a key aspect of e-commerce, such new customer information is highly beneficial to secondary vendor 104.

It is noted that payment gateways provide an embedded payment process that also avoids directing an online customer to a third-party to complete a payment process. In some embodiments, the functionality of e-commerce facilitator 130 is provided to the website of primary vendor 102 as part of embedded payment code that is associated with payment gateway 630 and is embedded in the website.

### Second Use Case

In an example second use case, e-commerce sales mechanism 121 is implemented as an application running on customer device 110, such as an online shopping application for a particular online merchant. In the second use case, primary vendor 102 is a conventional online merchant or retailer, and provides products and/or services via online sales. Therefore, in the second use case, primary vendor 102 includes some or all features of secondary vendors 104 for order fulfilment, as described above. In the second use case, e-commerce facilitator system 130 provides purchasing suggestions to a potential customer 101 of primary vendor 102 while the potential customer 101 uses the online shopping application of primary vendor 102. Because the purchasing suggestions provided by e-commerce facilitator system 130 can be based on a recommendation preference of primary vendor 102, primary vendor 102 can prevent certain purchasable items or categories of purchasable items from being recommended. Additionally or alternatively, primary vendor 102 can also prevent purchasable items provided by certain secondary vendors 104 and/or categories of secondary vendors 104. Thus, primary vendor 102 can control the purchasing recommendations that are provided to customer 101 via the online shopping application of primary vendor 102, even though primary vendor 102 does not actually determine the purchasing recommendations. Similarly, secondary vendors 104 can control the purchasing recommendations that are provided to customer 101 via the online shopping application of primary vendor 102, because the purchasing suggestions provided by e-commerce facilitator system 130 can be based on a recommendation preference of secondary vendor 104. Further, the secondary vendor 104 can receive revenue and new customer information without being subject to plan membership fees charged by primary vendor 102.

### Third Use Case

In an example third use case, e-commerce sales mechanism 121 is implemented as a website that includes software sales. In the second use case, primary vendor 102 is a conventional online software merchant or retailer, and provides software products via online sales. Therefore, in the third use case, primary vendor 102 may include some or all features of secondary vendors 104 for order fulfilment, as described above. In the third use case, e-commerce facilitator system 130 provides purchasing suggestions to potential customers 101 of primary vendor 102 when visiting the website of primary vendor 102 and/or searching for specific software products on the website of primary vendor 102. Because the purchasing suggestions provided by e-commerce facilitator system 130 can be based on customer information associated with customer 101, customer 101 can potentially be exposed to many more appropriate software products than are available from and/or known to primary vendor 102. As noted previously, small e-commerce vendors struggle for exposure to potential customers in the e-commerce space due to the many millions of e-commerce vendors and products that are available. Thus, in the third use case, a secondary vendor 104 can enjoy expanded exposure to new potential customers 101 that are engaged in a web session with the website of primary vendor 102, even when primary vendor 102 has no direct business relationship with the secondary vendor 104 (e.g., an affiliate-seller agreement and/or a reseller agreement).

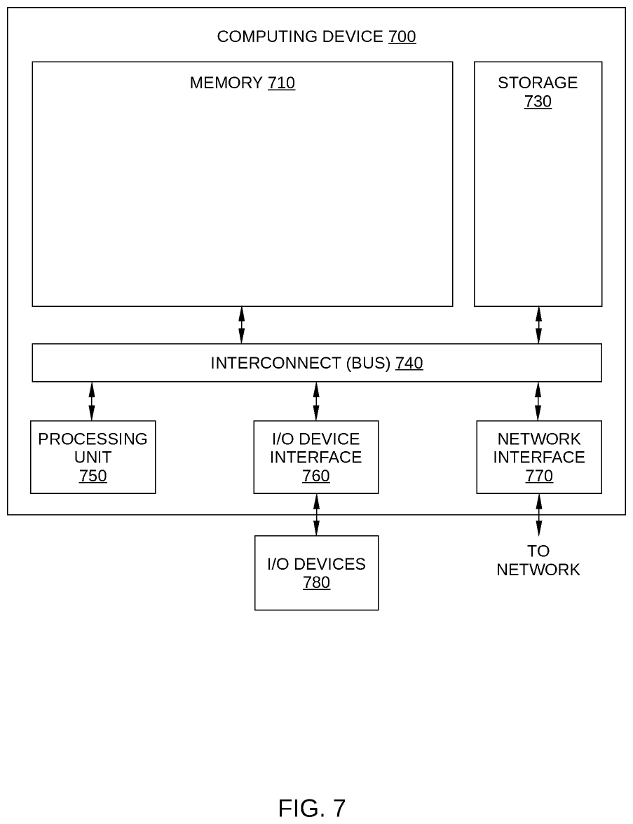

FIG. 7 is an illustration of a computing device 700 configured to perform various embodiments. Thus in some embodiments, computing device 700 can be implemented as or included in customer device 110, primary vendor e-commerce system 120, e-commerce facilitator system 130, and/or secondary vendor e-commerce system 140. Computing device 700 may be a desktop computer, a laptop computer, a smart phone, or any other type of computing device suitable for practicing one or more embodiments of the present disclosure. In operation, computing device 700 is configured to execute instructions associated with customer device 110, primary vendor e-commerce system 120, e-commerce facilitator system 130, and/or secondary vendor e-commerce system 140, as described herein. It is noted that the computing device described herein is illustrative and that any other technically feasible configurations fall within the scope of the present disclosure.

As shown, computing device 700 includes, without limitation, an interconnect (bus) 740 that connects a processing unit 750, an input/output (I/O) device interface 760 coupled to input/output (I/O) devices 780, memory 710, a storage 730, and a network interface 770. Processing unit 750 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU or digital signal processor (DSP). In general, processing unit 750 may be any technically feasible hardware unit capable of processing data and/or executing software applications, including e-commerce sales mechanism 121, local facilitator code 123, e-commerce sales mechanism 111, local facilitator code 112, web browser 113, recommendation engine 131, fund distribution system 135, item distribution tracker 136, sales receiving system 142, fund receiving system 143, and/or fulfillment system 144.

I/O devices 780 may include devices capable of providing input, such as a keyboard, a mouse, a touch-sensitive screen, and so forth, as well as devices capable of providing output, such as a display device and the like. Additionally, I/O devices 780 may include devices capable of both receiving input and providing output, such as a touchscreen, a universal serial bus (USB) port, and so forth. I/O devices 780 may be configured to receive various types of input from an end-user of computing device 700, and to also provide various types of output to the end-user of computing device 700, such as displayed digital images or digital videos. In some embodiments, one or more of I/O devices 780 are configured to couple computing device 700 to a network, such as the one or more communication networks 109 in FIGS. 1A and 1B.

Memory 710 may include a random access memory (RAM) module, a flash memory unit, or any other type of memory unit or combination thereof. Processing unit 750, I/O device interface 760, and network interface 770 are configured to read data from and write data to memory 710. Memory 710 includes various software programs that can be executed by processor 750 and application data associated with said software programs, including programs enabling or performing the herein-described functions of customer device 110, the herein-described functions of primary vendor e-commerce system 120, the herein-described functions of e-commerce facilitator system 130, and/or the herein-described functions of secondary vendor e-commerce system 140.

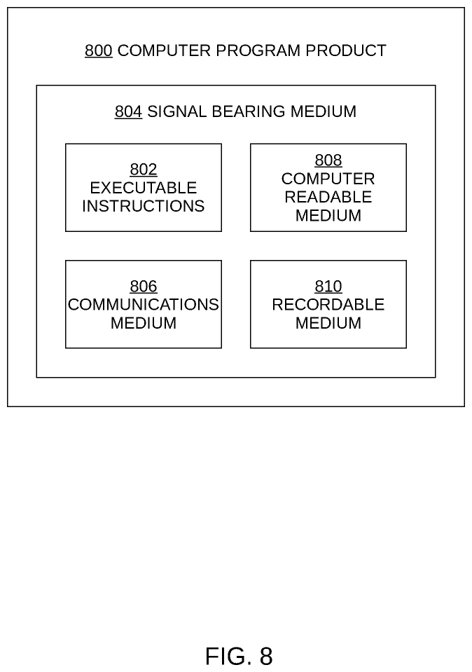

FIG. 8 is a block diagram of an illustrative embodiment of a computer program product 800 for implementing a method for segmenting an image, according to various embodiments. Computer program product 800 may include a signal bearing medium 804. Signal bearing medium 804 may include one or more sets of executable instructions 802 that, when executed by, for example, a processor of a computing device, may provide at least the functionality described above with respect to FIGS. 1A-6.

In some implementations, signal bearing medium 804 may encompass a non-transitory computer readable medium 808, such as, but not limited to, a hard disk drive, a Compact Disc (CD), a Digital Video Disk (DVD), a digital tape, memory, etc. In some implementations, signal bearing medium 804 may encompass a recordable medium 810, such as, but not limited to, memory, read/write (R/W) CDs, R/W DVDs, etc. In some implementations, signal bearing medium 804 may encompass a communications medium 806, such as, but not limited to, a digital and/or an analog communication medium (e.g., a fiber optic cable, a waveguide, a wired communications link, a wireless communication link, etc.). Computer program product 800 may be recorded on non-transitory computer readable medium 808 or another similar recordable medium 810.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A computer-implemented method for a first computing system of performing an online transaction via a communications network, the method comprising:
receiving, at the first computing system via the communications network, a request for a purchase recommendation for a customer of a primary vendor, wherein the request is initiated in response to an input to an electronic interface of an e-commerce sales mechanism associated with the primary vendor, and wherein the e-commerce sales mechanism is one of running on a second computing system associated with the customer or communicatively coupled to the second computing system associated with the customer;
determining, with the first computing system, the purchase recommendation for the customer based on first information included in the request and on second information included in a database associated with the first computing system, wherein the database includes information associated with a plurality of secondary vendors and the purchase recommendation includes at least one purchasable item that is not available for purchase from the primary vendor and is available for purchase from one of the plurality of secondary vendors; and
transmitting, with the first computing system via the communications network, the purchase recommendation to the e-commerce sales mechanism associated with the primary vendor, wherein the purchase recommendation is for display via the electronic interface.

2. The computer-implemented method of claim 1, further comprising:
receiving, at the first computing system via the communications network, an input via the electronic interface indicating a purchase request for the at least one purchasable item; and
transmitting, with the first computing system via the communications network, the purchase request to a third computing system associated with a secondary vendor from the plurality of secondary vendors, wherein the secondary vendor from the plurality of secondary vendors is associated with the purchasable item.

3. The computer-implemented method of claim 2, further comprising transmitting a first request to a payment processor for a first payment settlement between an account associated with the customer and an account associated with the primary vendor and a second request to the payment processor for a second payment settlement between the account associated with the customer and an account associated with the secondary vendor.

4. The computer-implemented method of claim 1, wherein the e-commerce sales mechanism associated with the primary vendor comprises a website running on the second computing system.

5. The computer-implemented method of claim 1, wherein the e-commerce sales mechanism associated with the primary vendor comprises an application running on the second computing system.

6. The computer-implemented method of claim 1, wherein determining the purchase recommendation for the customer is based on a characteristic of the at least one purchasable item.

7. The computer-implemented method of claim 6, wherein the characteristic of the at least one purchasable item comprises one of a physical feature of the at least one purchasable item, a price of the at least one purchasable item, a purchaser rating of the at least one purchasable item, or an availability of the at least one purchasable item.

8. The computer-implemented method of claim 1, wherein the first information includes at least one of a characteristic of the primary vendor, a recommendation preference received from the primary vendor, a previous purchase behavior of the customer with the primary vendor, customer-identifying information, purchase information for the customer associated with the primary vendor, purchase information for the customer associated with the secondary vendor, or customer browsing information associated with the primary vendor.

9. The computer-implemented method of claim 8, wherein the recommendation preference received from the primary vendor comprises one of a first category of e-commerce vendors whose purchasable items are not to be considered as the purchase recommendation or a second category of e-commerce vendors whose purchasable items are to be considered as the purchase recommendation.

10. The computer-implemented method of claim 9, wherein the first category of e-commerce vendors comprises one of e-commerce vendors that are direct competitors of the primary vendor, e-commerce vendors that are located in a specified geographical area, e-commerce vendors that have a customer rating that below a specified threshold, e-commerce vendors that sell a specified type of items, or specific e-commerce vendors proscribed by the primary vendor from being considered.

11. The computer-implemented method of claim 1, wherein the second information includes at least one of a characteristic of the secondary vendor or a recommendation preference received from the secondary vendor.

12. The computer-implemented method of claim 11, wherein the recommendation preference received from the secondary vendor comprises one of a first category of e-commerce vendors that are not to receive the purchase recommendation for a purchasable item available from the secondary vendor, a second category of e-commerce vendors that are to receive the purchase recommendation for the purchasable item available from the secondary vendor, or a category of purchasable items that are not to be considered as the purchase recommendation.

13. The computer-implemented method of claim 12, wherein the category of purchasable items that are not to be considered as the purchase recommendation comprises one of purchasable items having a buyer rating that is below a specified threshold, purchasable items that have a price above a first specified threshold, purchasable items that have a price below a second specified threshold, purchasable items made in a specified country, and purchasable items containing a specified material.

14. The computer-implemented method of claim 1, wherein the second information includes at least one of customer information associated with the secondary vendor, a previously defined recommendation preference of the primary vendor, a previously defined recommendation preference of the secondary vendor, a previous purchase behavior of the customer with the secondary vendor, or a previous purchase behavior of the customer with an e-commerce vendor that is neither the primary vendor nor the secondary vendor.

15. The computer-implemented method of claim 1, wherein the at least one purchasable item that is available from the secondary vendor comprises one of a product that is fulfilled by the secondary vendor or a service that is fulfilled by the secondary vendor.

16. The computer-implemented method of claim 1, wherein transmitting the purchase recommendation to the e-commerce sales mechanism comprises causing the information associated with the purchase recommendation to be displayed by the second computing system via the electronic interface associated with the e-commerce sales mechanism.

17. The computer-implemented method of claim 1, wherein there is no reseller agreement or affiliate-seller agreement between the primary vendor and any of the plurality of secondary vendors.

18. A non-transitory computer-readable medium that includes a set of instructions which, in response to execution by a processor of a computing system, cause the processor to perform the steps of:
receiving, at the first computing system via the communications network, a request for a purchase recommendation for a customer of a primary vendor, wherein the request is initiated in response to an input to an electronic interface of an e-commerce sales mechanism associated with the primary vendor, and wherein the e-commerce sales mechanism is one of running on a second computing system associated with the customer or communicatively coupled to the second computing system associated with the customer;
determining, with the first computing system, the purchase recommendation for the customer based on first information included in the request and on second information included in a database associated with the first computing system, wherein the database includes information associated with a plurality of secondary vendors and the purchase recommendation includes at least one purchasable item that is not available for purchase from the primary vendor and is available for purchase from one of the plurality of secondary vendors; and
transmitting, with the first computing system via the communications network, the purchase recommendation to the e-commerce sales mechanism associated with the primary vendor, wherein the purchase recommendation is for display via the electronic interface.

19. The non-transitory computer-readable medium of claim 18, further including instructions which, in response to execution by the processor of the computing system, cause the processor to perform the steps of:
receiving, at the first computing system via the communications network, an input via the electronic interface indicating a purchase request for the at least one purchasable item; and
transmitting, with the first computing system via the communications network, the purchase request to a third computing system associated with a secondary vendor from the plurality of secondary vendors, wherein the secondary vendor from the plurality of secondary vendors is associated with the purchasable item.

20. The non-transitory computer-readable medium of claim 18, wherein there is no reseller agreement or affiliate-seller agreement between the primary vendor and any of the plurality of secondary vendors.
